(19) United States
(12) Patent Application Publication
(10) Pub. No.: US 2023/0249276 A1
(43) Pub. Date: Aug. 10, 2023

(54) METHOD AND APPARATUS FOR GENERATING ARC IMAGE-BASED WELDING QUALITY INSPECTION MODEL USING DEEP LEARNING AND ARC IMAGE-BASED WELDING QUALITY INSPECTING APPARATUS USING THE SAME

(71) Applicant: PUKYONG NATIONAL UNIVERSITY INDUSTRY-UNIVERSITY COOPERATION FOUNDATION, Busan (KR)

(72) Inventors: Young Whan PARK, Busan (KR); Sol Mi LEE, Busan (KR); Jong Jung LEE, Geoje-si (KR); Seong Jun MUN, Ulsan (KR)

(73) Assignee: PUKYONG NATIONAL UNIVERSITY INDUSTRY-UNIVERSITY COOPERATION FOUNDATION, Busan (KR)

(21) Appl. No.: 18/160,478

(22) Filed: Jan. 27, 2023

(30) Foreign Application Priority Data
Feb. 4, 2022 (KR) 10-2022-0014802

(51) Int. Cl. B23K 9/10; B23K 31/00; B23K 31/12; B23K 9/095; B23K 15/00

(52) U.S. Cl. CPC B23K 9/1062; B23K 31/006; B23K 31/125; B23K 9/0956; B23K 15/0073

(57) ABSTRACT

An apparatus for generating arc image-based welding quality inspection model is disclosed. The apparatus includes: a hall sensor for measuring a welding current flowing in a base metal through an arc welding machine; a voltage meter for measuring a welding voltage through a circuit generated between the arc welding machine and the base metal; a camera for capturing an image of a welding target area on which the arc welding machine performs welding; and a model generator configured to: identify a welding state based on the welding current measured using the hall sensor and the welding voltage measured using the voltage meter; obtain an arc image based on the image captured; associate the obtained arc image with a welding quality identified based on the arc image to generate a dataset; and apply the generated dataset to a deep-learning model to generate an arc image-based welding quality inspection model.

### CROSS-REFERENCE TO RELATED APPLICATION

This application claims priority from Korean Patent Application No. 10-2022-0014802 filed on Feb. 4, 2022 in the Korean Intellectual Property Office, and all the benefits accruing therefrom under 35 U.S.C. 119, the contents of which in its entirety are herein incorporated by reference.

### BACKGROUND

### Field

The present disclosure relates to a technology capable of monitoring a welding quality in real time. More specifically, the present disclosure relates to a method and apparatus for generating an arc image-based welding quality inspection model that can monitor a welding quality in real time based on classifying and learning results of an arc image acquired via a camera, and to an arc image-based welding quality monitoring apparatus using the same.

### Description of Related Art

Aluminum alloy has a thermal conductivity three times higher than that of iron and a coefficient of thermal expansion about two times higher than that of iron. However, a melting temperature of the aluminum alloy is low, that is, about 660° C. Due to these characteristics, the aluminum alloy may have thermal deformation and crack after welding thereof. Pores are easily generated therein due to high hydrogen solubility in a liquid phase thereof. Welding defects such as porosity have a great influence on a strength of a welding part. In medium and small shipyards where a welding work is performed manually, a skilled welder is required to secure a welding quality, which causes a problem of increasing a time and a cost required for welding.

Tip-rotating arc welding arc welding may alleviate these defects. The tip-rotating arc welding has an effect of dispersing heat input due to tip rotation and reducing pores by generating a flow of a weld pool. Therefore, when the tip-rotating arc welding is applied to the aluminum alloy that it is difficult to weld, weldability of the aluminum alloy may be improved.

However, in automated welding technology such as the tip-rotating arc welding, means to monitor the welding quality in real time is required. Conventionally, technologies for monitoring the welding quality based on frequency analysis about sound, welding current, welding voltage, etc. have been studied. However, there is a problem in that accurate quality inspection is not achieved only with this analysis.

### PRIOR ART LITERATURE

### Patent Literature

Patent Document 1: Korean Patent 10-1779988 (2017 Sep. 13)

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a method and apparatus for generating an arc image-based welding quality inspection model that may monitor welding quality in real time based on classifying and learning results of arc images acquired through a camera, and an arc image-based welding quality monitoring apparatus using the same.

A purpose of the present disclosure is to provide a method and apparatus for generating an arc image-based welding quality inspection model that may accurately inspect welding quality even when it is difficult to determine the welding quality only with waveforms of welding current and the welding voltage, and an arc image-based welding quality monitoring apparatus using the same.

A purpose of the present disclosure is to provide a method and apparatus for generating an arc image-based welding quality inspection model in which a welding quality monitoring apparatus is implemented using a camera and an arc image-based welding quality inspection model so as to maintain and upgrade the model easily and to increase economic efficiency, and an arc image-based welding quality monitoring apparatus using the same.

Purposes in accordance with the present disclosure are not limited to the above-mentioned purpose. Other purposes and advantages in accordance with the present disclosure as not mentioned above may be appreciated from following descriptions and more clearly appreciated from embodiments in accordance with the present disclosure. Further, it will be readily appreciated that the purposes and advantages in accordance with the present disclosure may be realized by features and combinations thereof as disclosed in the claims.

A first aspect of the present disclosure provides an apparatus for generating arc image-based welding quality inspection model using deep-learning, the apparatus comprising: a welding bed for fixing a base metal and for transferring the base metal at a preset speed; a feeder for supplying a filler metal; an arc welding machine for welding the filler metal supplied from the feeder to the base metal using an arc; a hall sensor for measuring a welding current flowing in the base metal through the arc welding machine; a voltage meter for measuring a welding voltage through a circuit generated between the arc welding machine and the base metal; a camera for capturing an image of a welding target area on which the arc welding machine performs welding; a controller for controlling the welding bed, the feeder, and the arc welding machine to control a welding process, and for controlling the hall sensor, the voltage meter, and the camera to collect welding-related data during the welding process; and a model generator configured to: identify a welding state based on the welding current measured using the hall sensor and the welding voltage measured using the voltage meter; obtain an arc image based on the image captured using the camera; associate the obtained arc image with a welding quality identified based on the arc image to generate a dataset; and apply the generated dataset to a deep-learning model to generate an arc image-based welding quality inspection model.

In one implementation of the first aspect, the arc welding machine includes a tip-rotating arc welding machine.

In one implementation of the first aspect, the welding state includes an optimal state, a low heat input state, a high heat input state, a high voltage state, and a high current state.

In one implementation of the first aspect, the model generator is further configured to: obtain an arc area from the acquired arc image; calculate a length of the arc based on the arc area; determine whether the welding quality is good or bad, based on the calculated arc length; and associate the determined welding quality and the obtained arc image with each other to generate the dataset.

In one implementation of the first aspect, the model generator is further configured to: classify the arc image as an arc image corresponding to each of welding states including an optimal state, a low heat input state, a high heat input state, a high current state, and a high voltage state; and associating the welding quality identified based on the arc length calculated from each of the classified arc images with each of the classified arc images to generate a predefined number or greater of datasets.

In one implementation of the first aspect, the model generator is further configured to threshold a remaining pixel area except for a pixel area having preset RGB values in the arc image to obtain the arc area.

In one implementation of the first aspect, when a plurality of arc areas are extracted after the thresholding, the model generator is further configured to extract an arc area contained in a preset bounding box.

In one implementation of the first aspect, the model generator is further configured to calculate the length of the arc, based on a number of pixels of the extracted arc area.

In one implementation of the first aspect, the deep-learning model includes a first convolution layer, a second convolution layer, a third convolution layer, and a fourth convolution layer, wherein the first convolution layer includes a Conv2D layer, a max pooling layer, and a ReLU activation function, wherein in the Conv2D layer, a number of convolution filters is 32, and a convolution kernel has a (3,3) size, wherein the second convolution layer includes a Conv2D layer, a max pooling layer, and a ReLU activation function, wherein in the Conv2D layer, a number of convolution filters is 32, and a convolution kernel has a (3,3) size, wherein the third convolution layer includes a Conv2D layer, a max pooling layer, and a ReLU activation function, wherein in the Conv2D layer, a number of convolution filters is 64, and a convolution kernel has a (3,3) size, and wherein the fourth convolution layer includes a Conv2D layer, a max pooling layer, and a ReLU activation function, wherein in the Conv2D layer, a number of convolution filters is 64, and a convolution kernel has a (3,3) size.

A second aspect of the present disclosure provides a method for generating an arc image-based welding quality inspection model using deep-learning, the method comprising: measuring, by a hall sensor, a welding current flowing in a base metal through an arc welding machine; measuring, by a voltage meter, a welding voltage through a circuit generated between the arc welding machine and the base metal; capturing, by a camera, an image of a welding target area on which the arc welding machine performs welding; identifying, by a model generator, a welding state based on the welding current measured using the hall sensor and the welding voltage measured using the voltage meter; obtaining, by the model generator, an arc image based on the image captured using the camera; associating, by the model generator, the obtained arc image with a welding quality identified based on the arc image to generate a dataset; and applying, by the model generator, the generated dataset to a deep-learning model to generate an arc image-based welding quality inspection model.

In one implementation of the second aspect, associating, by the model generator, the obtained arc image with the welding quality identified based on the arc image to generate the dataset includes: obtaining, by the model generator, an arc area from the acquired arc image; calculating, by the model generator, a length of the arc based on the arc area; determining, by the model generator, whether the welding quality is good or bad, based on the calculated arc length; and associating, by the model generator, the determined welding quality and the obtained arc image with each other to generate the dataset.

In one implementation of the second aspect, calculating, by the model generator, the length of the arc based on the arc area includes thresholding, by the model generator, a remaining pixel area except for a pixel area having preset RGB values in the arc image to obtain the arc area.

In one implementation of the second aspect, a plurality of arc areas are extracted after the thresholding, wherein obtaining, by the model generator, the arc area from the acquired arc image includes extracting, by the model generator, an arc area contained in a preset bounding box.

A third aspect of the present disclosure provides an apparatus for monitoring a welding quality based on an arc image, the apparatus comprising: a welding bed for fixing a base metal and for transferring the base metal at a preset speed; a feeder for supplying a filler metal; an arc welding machine for welding the filler metal supplied from the feeder to the base metal using an arc; a camera for capturing an image of a welding target area on which the arc welding machine performs welding; a controller for controlling the welding bed, the feeder, and the arc welding machine to control the welding process; and a monitoring unit configured to: acquire an arc image based on the image captured using the camera; and identify whether a welding quality is good or bad, based on the arc image.

As described above, according to a method for generating an arc image-based welding quality inspection model using deep-learning, and an apparatus for generating an arc image-based welding quality inspection model using deep-learning according to the present disclosure, and an arc image-based welding quality monitoring apparatus using the same may monitor the welding quality in real time based on classifying and learning results of the arc image acquired through the camera.

A method for generating an arc image-based welding quality inspection model using deep-learning, and an apparatus for generating an arc image-based welding quality inspection model using deep-learning according to the present disclosure, and an arc image-based welding quality monitoring apparatus using the same may accurately inspect the welding quality even when it is difficult to determine the welding quality only with the welding current and the welding voltage waveforms.

A method for generating an arc image-based welding quality inspection model using deep-learning, and an apparatus for generating an arc image-based welding quality inspection model using deep-learning according to the present disclosure, and an arc image-based welding quality monitoring apparatus using the same may implement a welding quality monitoring apparatus using a camera and an arc image-based welding quality inspection model so as to maintain and upgrade the model easily and to increase economic feasibility.

In addition to the effects as described above, specific effects in accordance with the present disclosure will be described together with following detailed descriptions for carrying out the disclosure.

### BRIEF DESCRIPTION OF DRAWINGS

FIG. 1 is a diagram showing a configuration of an apparatus for generating an arc image-based welding quality inspection model using deep-learning according to an embodiment of the present disclosure.

FIGS. 2A-B show a torch of a tip-rotating arc welding machine.

FIG. 3 shows tip-rotating weaving during a welding process using a tip-rotating arc welding machine.

FIG. 4 shows a bead appearance, a bead cross-section, a welding current waveform and a welding voltage waveform when a welding state is an optimal state.

FIG. 5 shows a bead appearance, a bead cross-section, a welding current waveform and a welding voltage waveform when a welding state is a low heat input state.

FIG. 6 shows a bead appearance, a bead cross-section, a welding current waveform, and a welding voltage waveform when a welding state is a high heat input state.

FIG. 7 shows a bead appearance, a bead cross-section, a welding current waveform and a welding voltage waveform when a welding state is a high current state.

FIG. 8 shows a bead appearance, a bead cross-section, a welding current waveform, and a welding voltage waveform when a welding state is a high voltage state.

FIGS. 9A-C are diagrams showing a process of obtaining an arc image based on an image taken by a camera.

FIG. 10 is a diagram showing a waveform of welding current and a waveform of welding voltage when a welding state is an optimal state.

FIG. 11 is a diagram showing a waveform of welding current and a waveform of welding voltage when a welding state is a high voltage state.

FIGS. 12A-C are diagrams showing a bead cross-section when a welding state is an optimal state and a bead cross-section when a welding state is a high voltage state.

FIG. 13 is a graph showing an arc length when a welding state is an optimal state.

FIG. 14 is a graph showing an arc length when a welding state is a high voltage state.

FIG. 15 is a graph showing an example of an arc length when a welding quality is bad.

FIG. 16 is a graph showing another example of an arc length when a welding quality is bad.

FIG. 17 is a diagram showing an example of a deep-learning model that generates an arc image-based welding quality inspection model.

FIGS. 18A-B showing an output value predicted through an arc image-based welding quality inspection model.

FIG. 19 is a diagram showing a result of determining a welding quality based on an arc length measured based on an actual arc image.

FIG. 20 is a diagram showing a configuration of an arc image-based welding quality monitoring apparatus according to an embodiment of the present disclosure.

FIG. 21 is a flowchart for illustrating a method for generating an arc image-based welding quality inspection model using deep-learning according to an embodiment of the present disclosure.

### DETAILED DESCRIPTIONS

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify an entirety of list of elements and may not modify the individual elements of the list. When referring to “C to D”, this means C inclusive to D inclusive unless otherwise specified.

It will be understood that, although the terms “first”, “second”, “third”, and so on may be used herein to illustrate various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like may be disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like may be disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one example, when a certain embodiment may be implemented differently, a function or operation specified in a specific block may occur in a sequence different from that specified in a flowchart. For example, two consecutive blocks may be actually executed at the same time. Depending on a related function or operation, the blocks may be executed in a reverse sequence.

In descriptions of temporal relationships, for example, temporal precedent relationships between two events such as “after”, “subsequent to”, “before”, etc., another event may occur therebetween unless “directly after”, “directly subsequent” or “directly before” is not indicated.

The features of the various embodiments of the present disclosure may be partially or entirely combined with each other, and may be technically associated with each other or operate with each other. The embodiments may be implemented independently of each other and may be implemented together in an association relationship.

Spatially relative terms, such as “beneath,” “below,” “lower,” “under,” “above,” “upper,” and the like, may be used herein for ease of explanation to illustrate one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented, for example, rotated 90 degrees or at other orientations, and the spatially relative descriptors used herein should be interpreted accordingly.

Hereinafter, specific details for implementing a method for generating an arc image-based welding quality inspection model using deep-learning, and an apparatus for generating an arc image-based welding quality inspection model using deep-learning according to the present disclosure, and an arc image-based welding quality monitoring apparatus using the same will be described.

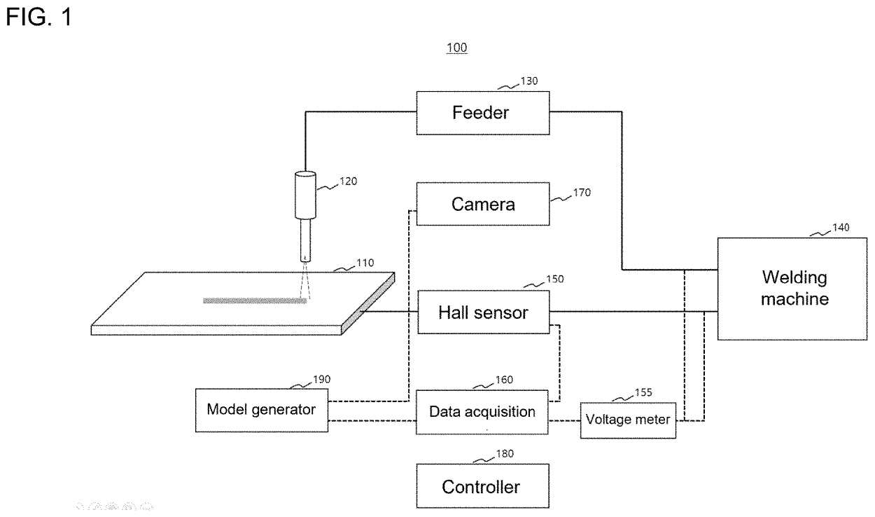

FIG. 1 is a diagram showing a configuration of an apparatus for generating an arc image-based welding quality inspection model using deep-learning according to an embodiment of the present disclosure.

Referring to FIG. 1, an apparatus 100 for generating an arc image-based welding quality inspection model using deep-learning includes a welding bed 110, a torch 120a of a welding machine (Tip-Rotating Arc Welding machine), a feeder 130, an arc welding machine 140, a hall sensor 150, a voltage meter 155, a DAQ board (data acquisition board) 160, a camera 170, a controller 180 and a model generator 190.

The welding bed 110 fixes a base metal and transfers the base metal at a preset speed under control of the controller. For example, the welding bed 110 may be composed of a 3-axis carriage robot system, and the base metal may be fixed on the welding bed of the robot with a jig. The robot may transport the welding bed in the opposite direction to a welding direction according to a set speed and may weld the base metal.

The welding machine torch 120 may correspond to a torch of the tip-rotating arc welding machine in which a tip is rotated by a motor and an eccentric disk. The tip-rotating arc welding machine is an apparatus that perform welding while rotating a tip of the torch to use spatial modulation.

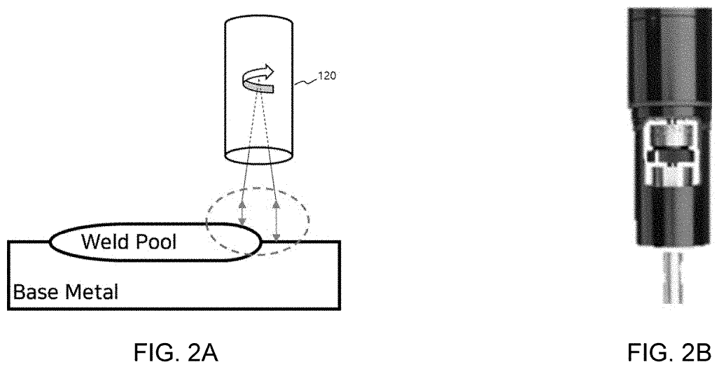

FIGS. 2A-B show the torch of the tip-rotating arc welding machine.

Referring to FIG. 2A, the torch 120 of the tip-rotating arc welding machine welds a filler metal to the base metal while the arc rotates spatially as the tip rotates.

FIG. 2B shows a structure of the torch of the tip-rotating arc welding machine. The torch 120 includes a hollow shaft motor and an eccentric disc therein. The tip thereof rotates to supply a welding wire (filler metal). A tip-rotating arc welding scheme has an effect of dispersing heat input as the tip rotates. The rotation causes flow of a weld pool such that some pores exit to reduce the pores. Further, the tip-rotating arc welding scheme may obtain a larger fill area based on the same heat input due to a centripetal force, thereby increasing a production amount.

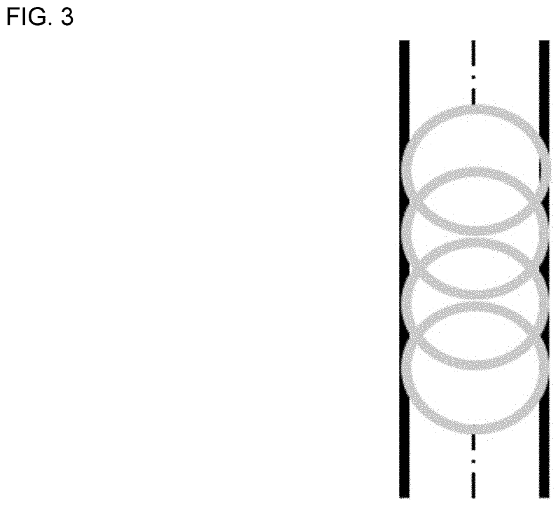

FIG. 3 is a diagram showing tip-rotating weaving during a welding process using the tip-rotating arc welding machine.

Referring to FIG. 3 showing weaving of tip-rotating welding, welding proceeds in a straight line while rotating, there is no change in a speed, sot that constant welding properties may be secured. Further, the weaving welding scheme is applied to a robot, so that a welding speed thereof is higher than that of a straight welding scheme. A welding bead formation range thereof is wider, and a fill area is larger, so that productivity may be increased.

Referring back to FIG. 1, the feeder 130 supplies the filler metal to the welding machine torch 120. The arc welding machine 140 may generate an arc from the welding machine torch 120 using a gas for welding, such as argon gas. The arc welding machine 140 may weld the filler metal supplied through the feeder 130 to the base metal using the arc. In one embodiment, the base metal may be an Al 5083 alloy, and the filler metal may be an ER 5183 welding wire having properties similar to those of the base metal. A chemical composition of each of the base metal and the filler metal is shown in Table 1 below.

TABLE 1

| Element | | | | | | | | |
|---|---|---|---|---|---|---|---|---|
| Si | Fe | Cu | Mn | Mg | Zn | Cr | Ti | Al |

Chemical composition of Al 5083 (wt. %)

| | | | | | | | | | |
|---|---|---|---|---|---|---|---|---|---|
| (%) | 0.40 | 0.40 | 0.10 | 0.7 | 4.5 | 0.25 | 0.15 | 0.15 | Bal |

Chemical composition of ER 5183 (wt. %)

| | | | | | | | | | |
|---|---|---|---|---|---|---|---|---|---|
| (%) | 0.40 | 0.40 | 0.10 | 0.75 | 4.75 | 0.15 | 0.11 | 0.15 | Bal |

The hall sensor 150 measures welding current flowing in the base metal through the arc welding machine 140 during the welding process. The hall sensor 150 measures the welding current flowing in the base metal using the Hall-effect. The hall sensor 150 transmits a current signal corresponding to the measured current to the DAQ board 160.

The voltage meter 155 measures welding voltage via an electrical circuit generated between the arc welding machine 140 and the base metal 110 during the welding process. The voltage meter 155 transmits a voltage signal corresponding to the measured voltage to the DAQ board 160.

The DAQ board 160 collects the welding current and the welding voltage and sends the collected current and voltage to the model generator 190. In one embodiment, an output range of the DAQ board 160 may be set to 10 V and a sampling rate thereof may be set to 10 ks/s. In one embodiment, the DAQ board 160 may be embodied as an NI USB-6221 BNC.

The camera 170 captures an image of a welding target area on which the arc welding machine performs welding 140. The camera 170 transmits the captured image to the model generator 190. In one embodiment, since brightness of welding light is very high, a filter may be provided in the camera 170 to mitigate the brightness. For example, the camera 170 may include a neutral density filter and a band pass filter for mitigating light in an unnecessary band.

The controller 180 controls the welding process by controlling the welding bed 110, the feeder 130, and the arc welding machine 140 according to preset setting information. Further, the controller 180 controls the hall sensor 150, the voltage meter 155, and the camera 170 to collect welding-related data including the welding current, the welding voltage, and the images during the welding process.

The model generator 190 identifies a welding state based on the welding current measured using the hall sensor 150 and the welding voltage measured using the voltage meter 155. In one embodiment, the model generator 190 may identify the welding state including an optimal state, a low heat input state, a high heat input state, a high voltage state, and a high current state. The model generator 190 may pre-store welding state information based on welding current and the welding voltage, and welding quality information based on the welding state, and may identify the welding state and welding quality using the prestored information.

The welding state may vary depending on a welding condition. In following descriptions, for convenience of description, it is assumed that a CTWD (Contact Tip to Workpiece Distance; a distance from the tip of the torch to a welding material) is 18 mm, a shielding gas is 99/9% Ar, a gas flow rate is 25 I/min, a welding speed is 90 cm/min, a rotating diameter of the tip is 3 mm, and a tip rotation speed (Rotation Per Minute) is 500 RPM.

In one embodiment, a welding state based on the welding current and the welding voltage, and the welding quality (good or bad) based on the welding state may be pre-identified based on an experiment. For example, Table 2 below is an example of the welding state based on the welding current and the welding voltage identified in advance based on the experiment under the above welding condition.

TABLE 2

| Condition | Current (A) | Voltage (V) |
|---|---|---|
| Low heat input | 230 | 20 |
| High heat input | 230 | 29 |
| Low heat input | 240 | 21 |
| High heat input | 240 | 28 |
| Optimal | 260 | 24 |
| Optimal | 270 | 25 |
| Optimal | 280 | 26 |
| High heat input | 290 | 27 |
| High current | 300 | 23 |
| High current | 300 | 24 |
| High current | 300 | 25 |

The welding quality may be determined as bad or good based on following three criteria: whether welding is completed, bead quality, and penetration depth. When at least one of the three criteria: whether welding is completed, bead quality, and penetration depth is determined as normal, the welding quality may be determined as bad.

For example, whether welding is completed may be identified based on the bead appearance. An event in which the tip of the torch is melted and thus the wire is no longer supplied may occur, or an event in which the wire is not melted due to insufficient heat input thereto and thus the wire is not supplied may occur. An event in which the welding is stopped due to an error in the welding machine. In this case, whether the welding is completed may be determined to be normal.

The bead quality may be identified based on the bead appearance. When defects such as undercut or humping that may be identified on the appearance of the bead are found, the bead quality may be determined to be bad.

The penetration depth may be identified based on the bead cross-section. When the penetration depth is within a predetermined range in consideration of the welding condition, the penetration depth may be determined to be normal. Otherwise, the penetration depth may be determined to be abnormal. For example, when a bead-on-plate (BOP) is welded on a base metal having a thickness of 6 mm, the penetration depth may be determined to be normal when the penetration depth is 3 mm or larger.

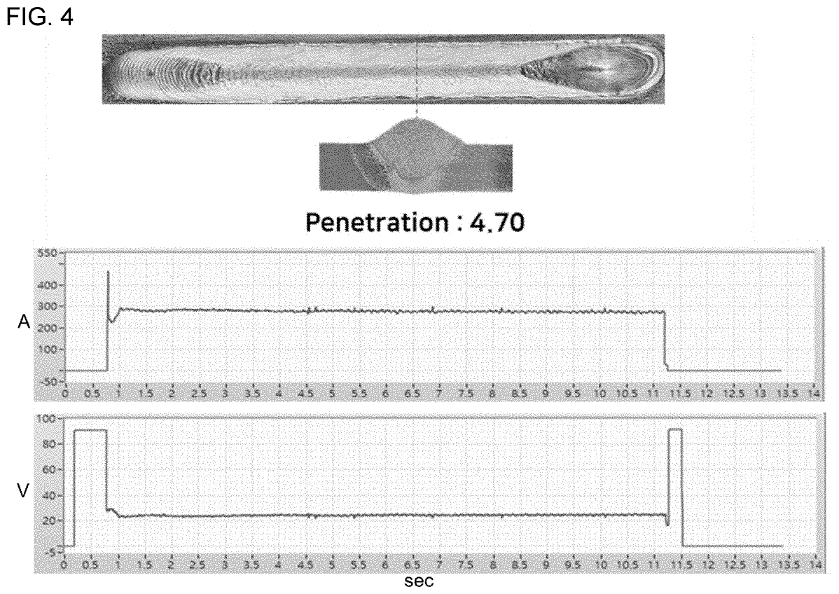

FIG. 4 is a diagram showing a bead appearance, a bead cross-section, a welding current waveform, and a welding voltage waveform when a welding state is an optimal state.

Referring to FIG. 4, in the case of the optimal state, as may be identified from the bead appearance obtained through the experiment, whether the welding is competed is normal, and there are no defects such as undercut and humping, so that the bead quality is normal. The penetration depth is 4.7 mm, and the penetration depth may be identified to be normal.

A waveform graph of each of the welding current and the welding voltage in FIG. 4 is a diagram showing a waveform over time of a value measured using each of the hall sensor 150 and the voltage meter 155 when each of the welding current and the welding voltage (for example, 280 A welding current and 26V welding voltage) in an optimal state is applied from the arc welding machine 140. Referring to the waveform graph of each of the welding current and the welding voltage, it may be identified that the welding current and voltage are maintained stably, except at a beginning of welding and an end of welding corresponding to both opposing ends of the graph.

When each of the welding current and the welding voltage as measured by each of the hall sensor 150 and the voltage meter 155 shows a waveform pattern as shown in FIG. 4, the model generator 190 may identify that the welding state is optimal and the welding quality is good.

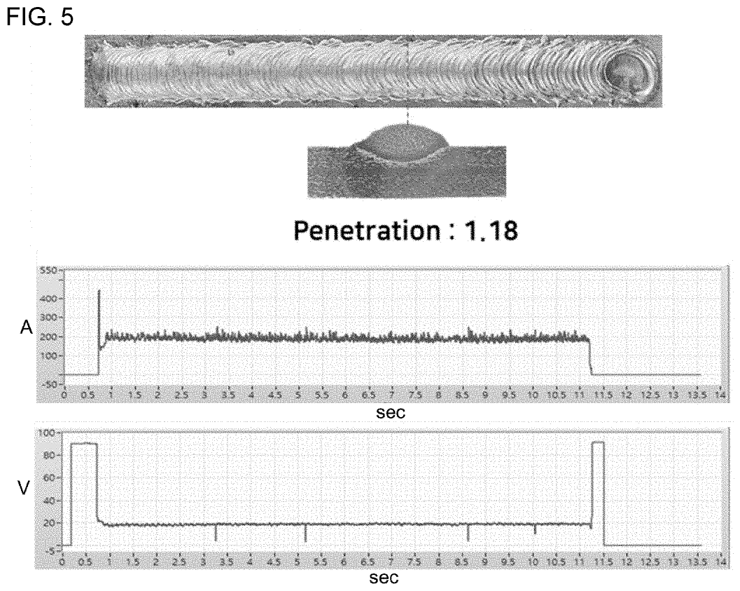

FIG. 5 is a diagram showing a bead appearance, a bead cross-section, a welding current waveform and a welding voltage waveform when a welding state is a low heat input state.

Referring to FIG. 5, in the case of the low heat input state, as may be identified from the bead appearance obtained through the experiment, whether welding is completed is positive. However, the bead quality is bad. The penetration depth may be identified as abnormal because a normal condition is not achieved.

A waveform graph of each of the welding current and the welding voltage in FIG. 5 is a diagram showing a waveform over time of a value measured using each of the hall sensor 150 and the voltage meter 155 when each of the welding current and the welding voltage (for example, 230 A welding current and 20V welding voltage) in a low heat input state is applied from the arc welding machine 140. Referring to the waveform graph of the welding current and the waveform graph of the welding voltage, it may be identified that there is a pattern in which fluctuation of the waveform of the welding current increases and the welding voltage drops sharply.

When each of the welding current and the welding voltage measured by each of the hall sensor 150 and the voltage meter 155 shows the waveform pattern as shown in FIG. 5, the model generator 190 may identify that the welding state is a low heat input state and the welding quality is bad.

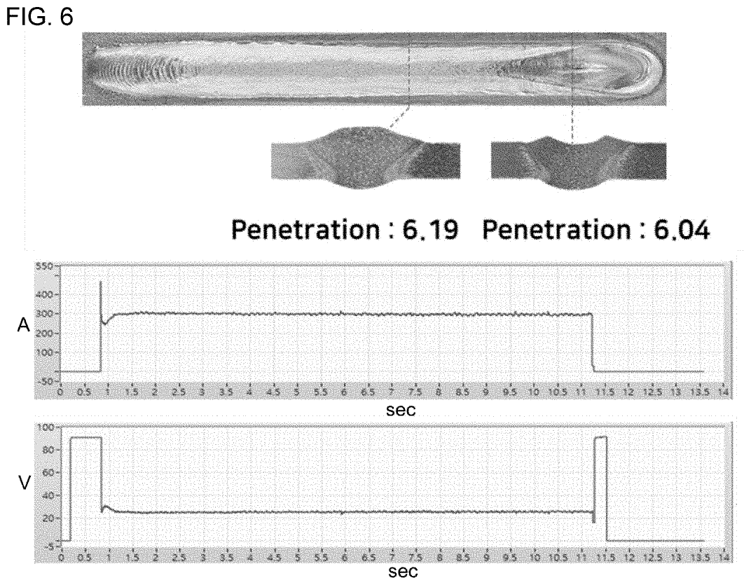

FIG. 6 is a diagram showing a bead appearance, a bead cross-section, a welding current waveform and a welding voltage waveform when a welding state is a high heat input state.

Referring to FIG. 6, in the case of the high heat input state, as may be identified from the bead appearance obtained through the experiment, it may be identified that whether welding is completed is positive, and the penetration depth is normal. However, it may be identified that the bead quality is bad.

A waveform graph of each of the welding current and the welding voltage in FIG. 6 is a diagram showing a waveform over time of a value measured using each of the hall sensor 150 and the voltage meter 155 when each of the welding current and the welding voltage (for example, 290 A welding current and 27V welding voltage) in a high heat input state is applied from the arc welding machine 140. Referring to the waveform graph of each of the welding current and the welding voltage, it may be identified that the welding current and voltage are maintained stably, except at the beginning of welding and the end of welding corresponding to both opposing ends of the graph.

When each of the welding current and the welding voltage measured using each of the hall sensor 150 and the voltage meter 155 show the waveform pattern as shown in FIG. 6, the model generator 190 may identify that the welding state is a high heat input state and the welding quality is bad.

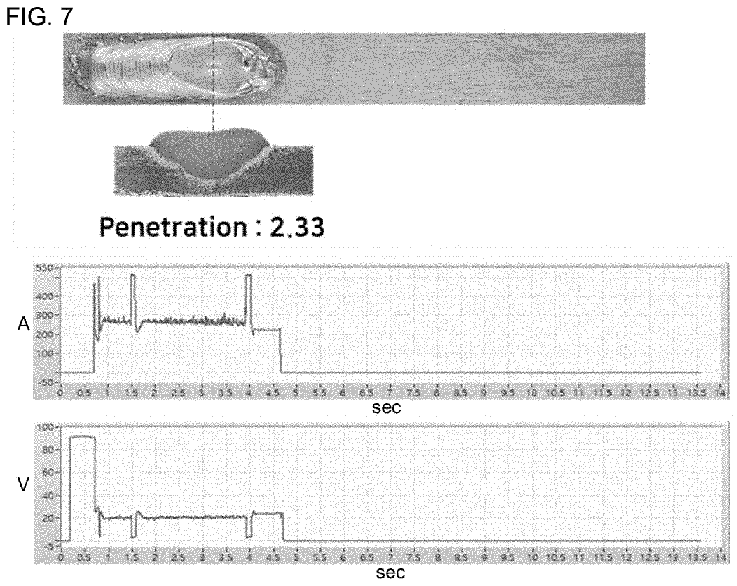

FIG. 7 is a diagram showing a bead appearance, a bead cross-section, a welding current waveform and a welding voltage waveform when a welding state is a high current state.

Referring to FIG. 7, in the case of the high current state, it may be identified that whether the welding is completed is negative and the bead quality is bad, as may be identified from the bead appearance obtained through the experiment. Further, the penetration depth may also be identified as being abnormal because a normal condition is not achieved.

A waveform graph of each of the welding current and the welding voltage in FIG. 7 is a diagram showing a waveform over time of a value measured using each of the hall sensor 150 and the voltage meter 155 when each of the welding current and the welding voltage (for example, 300 A welding current and 23V welding voltage) in a high current state is applied from the arc welding machine 140. Referring to the waveform graph of each of the welding current and the welding voltage, it may be identified that each of the welding current and voltage is unstable and the waveform thereof is short.

When each of the welding current and the welding voltage measured using each of the hall sensor 150 and the voltage meter 155 shows the waveform pattern as shown in FIG. 7, the model generator 190 may identify that the welding state is the high current state and the welding quality is bad.

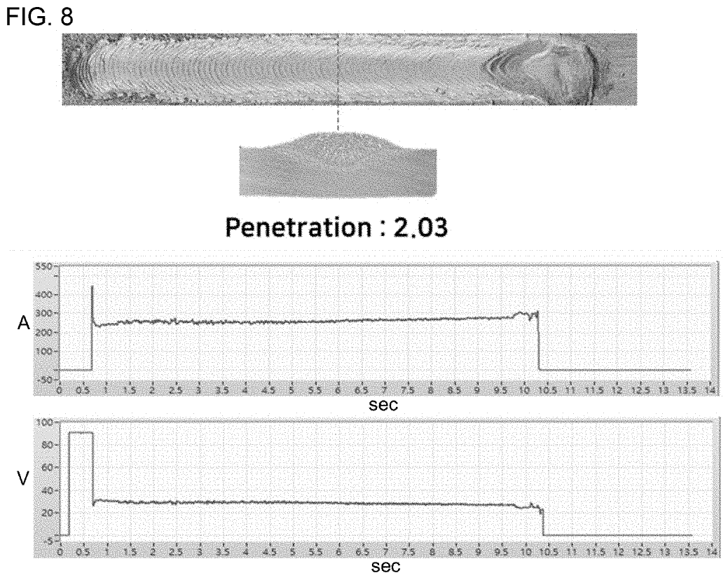

FIG. 8 is a diagram showing a bead appearance, a bead cross-section, a welding current waveform, and a welding voltage waveform when a welding state is a high voltage state.

Referring to FIG. 8, in the case of the high voltage state, as may be identified from the bead appearance obtained through the experiment, it may be identified that whether welding is completed is positive. However, the bead quality is identified as being bad. Further, the penetration depth may be identified as being abnormal because a normal condition is not achieved.

A waveform graph of each of the welding current and the welding voltage in FIG. 8 is a diagram showing a waveform over time of a value measured using each of the hall sensor 150 and the voltage meter 155 when each of the welding current and the welding voltage (for example, 230 A welding current and 29V welding voltage) in a high voltage state is applied from the arc welding machine 140. Referring to each of the welding current waveform graph and the welding voltage waveform graph, it may be identified that each of the welding current and the welding voltage is maintained to be stable, whereas the welding voltage rapidly drops when the welding ends.

When each of the welding current and the welding voltage measured using each of the hall sensor 150 and the voltage meter 155 shows the waveform pattern as shown in FIG. 8, the model generator 190 may identify that the welding state is the high voltage state and the welding quality is bad.

Referring back to FIG. 1, the model generator 190 acquires an arc image based on the image captured by the camera 170.

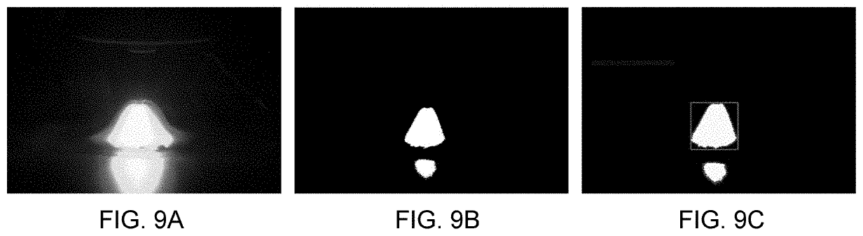

FIGS. 9A-C are diagrams showing a process of obtaining an arc image based on the image taken by the camera.

Referring to FIG. 9A, the model generator 190 obtains the image captured by the camera 170 on a frame basis, and acquires the arc image therefrom and stores the same.

The model generator 190 preprocesses the acquired arc image to calculate an arc length, and determines whether the welding quality is good or bad based on the calculated arc length. The model generator 190 may associate the determined welding quality, the identified welding state, and the acquired arc image with each other to generate a dataset.

The model generator 190 preprocesses the acquired arc image as follows. In one embodiment, the model generator 190 calculates RGB values from each pixel of the arc image, and thresholds the remaining pixel areas except for a pixel area with preset RGB values to obtain an arc area in FIG. 9B. Via the thresholding using the RGB values, a plasma area and a shielding gas area around the arc light may be removed from the arc image. In the arc image subjected to the thresholding, a portion other than the arc area appears in black as shown in FIG. 9B.

The arc area mag be acquired in a different scheme according to an implementation example. For example, the model generator 190 calculates a luminance value of each pixel. Then, when a difference between an average luminance value of a pixel on one side of a specific pixel and an average luminance value of a pixel in the other side of the specific pixel is greater than or equal to a preset value, the model generator 190 may calculate the specific pixel as a boundary of the arc area. For example, a pixel satisfying a following Relationship 1 may be calculated as a boundary pixel of the arc area:

[Relationship 1]

$$\frac{1}{m} {\sum }_{x = d - 1 - m}^{d - 1} L ( x , y ) - \frac{1}{n} {\sum }_{x = d + 1}^{d + 1 + n} L ( x , y ) \geq {V}_{threshold 1}$$

$$or$$

$$\frac{1}{j} {\sum }_{y = d - 1 - j}^{d - 1} L ( x , y ) - \frac{1}{k} {\sum }_{y = d + 1}^{d + 1 + k} L ( x , y ) \geq {V}_{threshold 2}$$

In this regard, L(x,y) represents a luminance value of a (x,y) coordinate pixel, each of V_{threshold1} and V_{threshold2} represents a threshold value, and each of j, k, m, and n represents a natural number.

The model generator 190 may connect boundary pixels to each other to generate a closed curve, and identify an area surrounded with the closed curve. The model generator 190 may calculate an average luminance value of pixels in the identified area surrounded with the closed curve obtained by connecting the boundary pixels and then obtain an area having the brightest average luminance value as the arc area. In another implementation example, all areas obtained by the above two schemes may be identified as candidate arc areas, and the arc area may be obtained from candidate arc areas using a bounding box.

When a plurality of arc areas separated after the thresholding are extracted, the model generator 190 extracts the arc area included in a preset bounding box using the preset bounding box in FIG. 9C.

When the arc image includes arc light reflected from the surroundings other than the arc, for example, includes arc light reflected from the bead, a plurality of arc areas separated after thresholding may be included in the image. When the plurality of arc areas separated after thresholding are extracted, the model generator 190 may remove an area corresponding to the reflected arc light using the preset bounding box. For example, the model generator 190 may apply a bounding box with a size of a CTWD value to the image after the thresholding to remove the remaining area from a tip position of the torch 120 except for an area where the arc may exist.

The model generator 190 may calculate the arc length based on the number of pixels of the extracted arc area. For example, the model generator 190 may calculate the number of pixels at the largest length in a y-axis direction (vertical direction) in the extracted arc area and may calculate the arc length based on the calculated number.

The model generator 190 may determine whether the welding quality is good or bad, based on the calculated arc length.

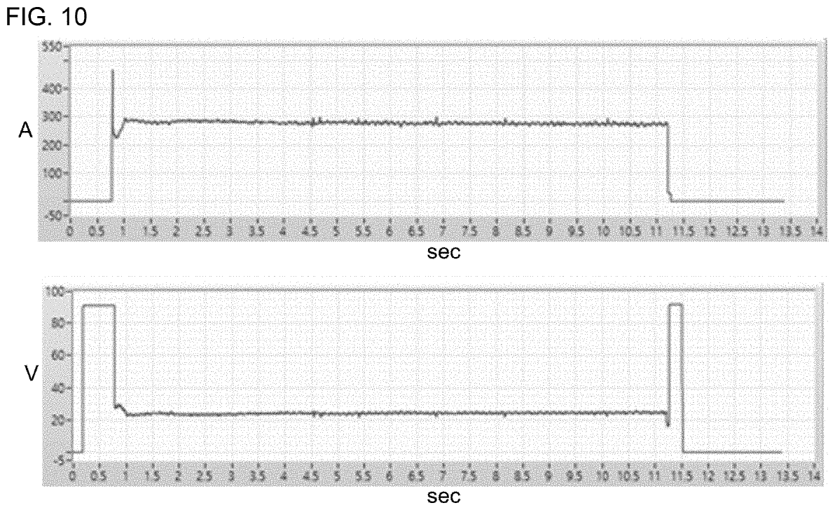

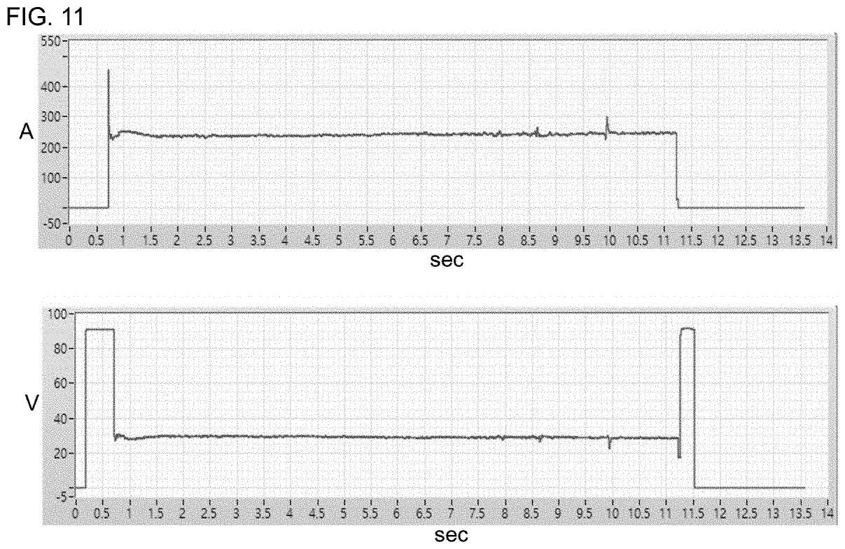

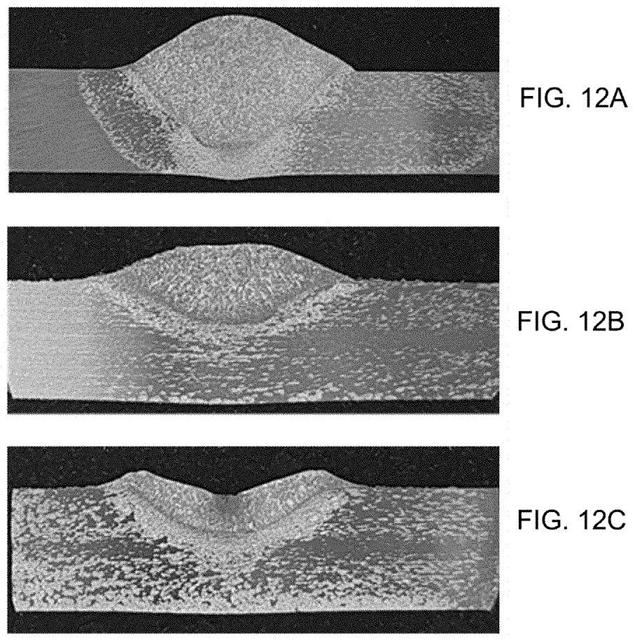

FIG. 10 is a diagram showing a waveform of the welding current and a waveform of the welding voltage when a welding state is an optimal state. FIG. 11 is a diagram showing a waveform of the welding current and a waveform of the welding voltage when a welding state is a high voltage state. FIGS. 12A-C are diagrams showing a bead cross-section when a welding state is an optimal state and a bead cross-section when a welding state is in a high voltage state.

FIG. 10 is directed to the optimal state of the welding current 280 A and the welding voltage 26V. FIG. 11 is directed to the high voltage state of the welding current 240 A and the welding voltage 28V. When comparing the waveforms of the welding currents and the welding voltages in FIG. 10 and FIG. 11 with each other, it may be identified that there is no difference between the waveform patterns. Therefore, the optimal state and the high voltage state are not distinguished from each other only based on the welding current and the welding voltage, such that the welding quality cannot be accurately identified.

However, when the bead cross-section (FIG. 12A) when a welding state is an optimal state and the bead cross-section (FIGS. 12B-C) when a welding state is a high voltage state are comparing with each other, it may be identified that a difference between penetration depths thereof is large.

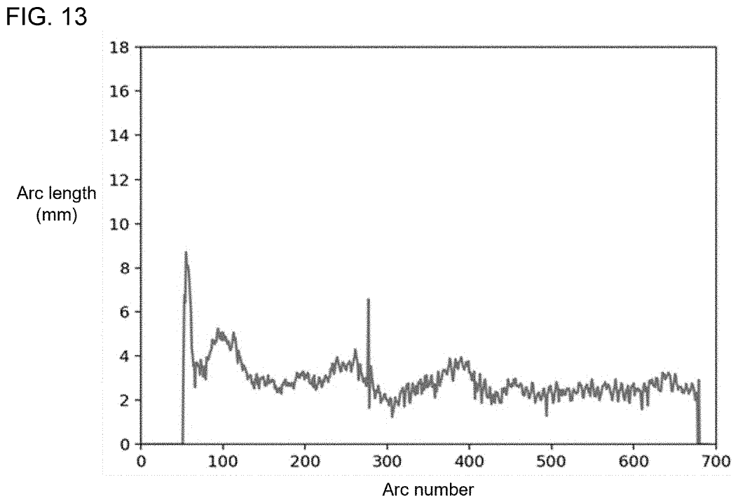

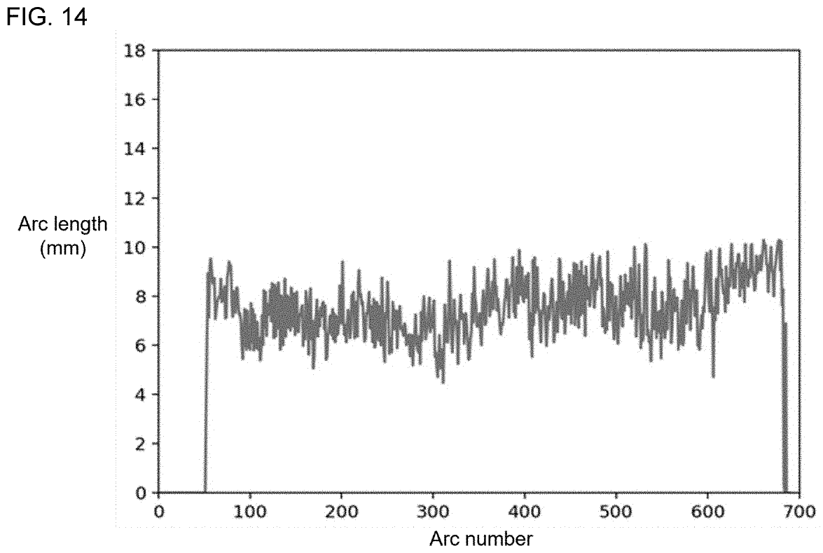

FIG. 13 is a graph showing an arc length when a welding state is an optimal state, and FIG. 14 is a graph showing an arc length when a welding state is a high voltage state.

FIG. 13 and FIG. 14 show results of calculating the arc length from the arc image in the optimal state and the arc image in the high voltage state, respectively using a method of measuring the arc length using the image as described in FIGS. 9A-C. Referring to FIG. 13, it may be identified that in the case of the optimal state, the arc length during the welding has a value between 2 mm and 6 mm. Further, referring to FIG. 14, it may be identified that in the case of the high voltage state, the arc length during the welding has a value between 6 mm and 10 mm.

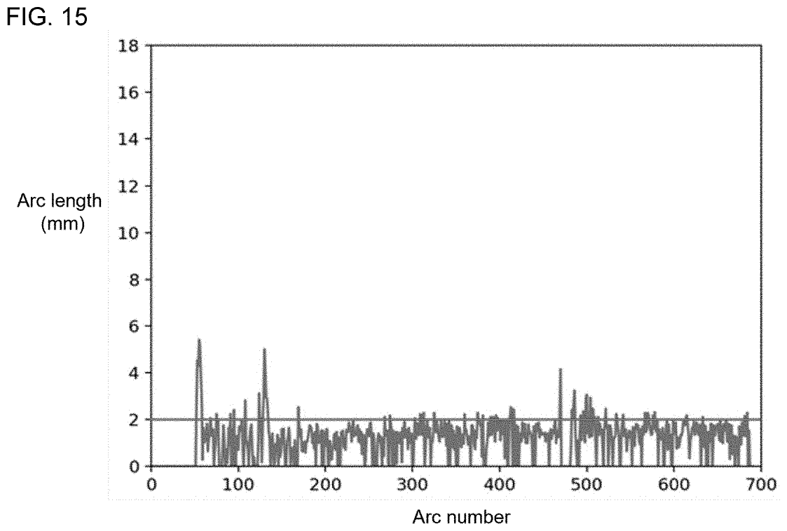

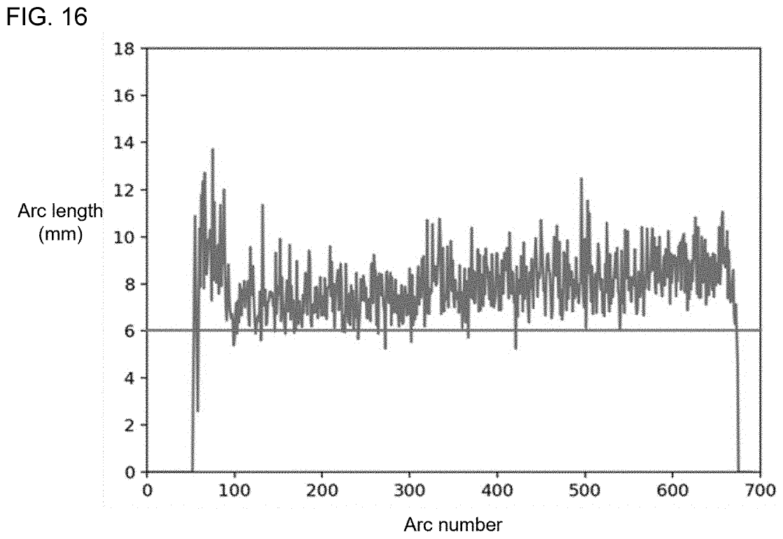

FIG. 15 is a graph showing an example of the arc length when the welding quality is bad, and FIG. 16 is a graph showing another example of the arc length when the welding quality is bad.

When the penetration depth did not exceed 3 mm, the arc length is found to be smaller than 2 mm or greater than 6 mm. In one embodiment, the model generator 190 may pre-store an arc length based on which it is determined whether the welding quality is good or bad. For example, the model generator 190 may determine that the welding quality is good when the calculated arc length is between 2 mm and 6 mm. The model generator 190 may determine that the welding quality is bad when the calculated arc length is smaller than 2 mm or greater than 6 mm. In one embodiment, a criterion based on which it is determined whether the welding quality is good or bad may vary depending on a welding condition.

Referring back to FIG. 1, the model generator 190 identifies whether the welding quality is good or bad, based on the calculated arc length and a preset arc length. In one embodiment, the model generator 190 may determine whether the welding quality is good or bad, based on the calculated arc length and the welding state identified based on the value measured using each of the hall sensor 150 and the voltage meter 155 at the time of acquiring a corresponding arc image. For example, the model generator 190 may identify that the welding quality is good when the arc length satisfies the above defined condition, and the welding state corresponds to the good welding quality at the same time. That is, when the length of the arc is in the range corresponding to the good welding quality, and the welding state identified based on the measured welding current and the measured welding voltage corresponds to the good welding quality, the model generator 190 may identify that the welding quality is good.

The model generator 190 may associate the identified welding quality with the corresponding arc image to generate a dataset, and may generate a preset number or greater of datasets for training the model. In one embodiment, the dataset may further include the identified welding state. In one embodiment, the model generator 190 may classify the arc images into arc images corresponding to following five welding states: optimal, low heat input, high heat input, high current and high voltage, and may associate the arc length calculated from a corresponding arc image with the welding quality identified based on the calculated arc length to generate a predetermined number or greater of datasets. In one embodiment, the model generator 190 may generate a predetermined number or greater of datasets per based on the arc image corresponding to each of the five welding states.

The model generator 190 may apply the generated datasets to a deep-learning model to generate an arc image-based welding quality inspection model. In one embodiment, the deep-learning model may use a convolutional neural network (CNN), a loss function may use Binary crossentropy, and an optimization function may use Adam.

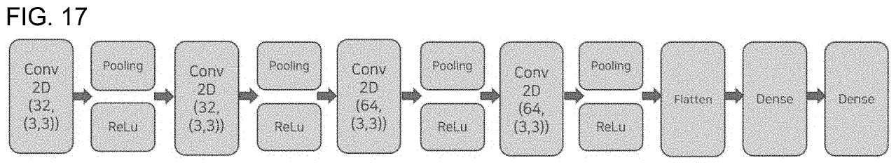

FIG. 17 is a diagram showing an example of a deep-learning model that generates an arc image-based welding quality inspection model.

The convolutional neural network (CNN) is largely composed of a convolution layer, and a pooling layer. The convolution layer plays a role in extracting features of an image via a convolution operation and an activation function. The convolution layer may apply the activation function to a value calculated via the convolution operation to determine an output value thereof. For example, the activation function may include a step function, a sigmoid function, a hyperbolic tangent function, a ReLU function, a leaky ReLU, and the like.

The pooling layer performs a pooling operation that down-samples a feature map to reduce a size of the feature map. For example, the pooling layer may include a max pooling layer and an average pooling layer.

In one embodiment, a first convolution layer of the deep-learning model that generates the arc image-based welding quality inspection model of FIG. 17 includes a Conv2D layer. The number of convolution filters in the Conv2D layer is 32, and a convolution kernel thereof has a (3.3) size. The pooling layer may include the max pooling layer. The activation function may include the ReLU function ReLU.

A second convolution layer thereof includes a Conv2D layer. The number of convolution filters in the Conv2D layer is 32, and a convolution kernel thereof has a (3,3) size. The pooling layer may include the max pooling layer. The activation function may include the ReLU function ReLU.

A third convolution layer thereof includes a Conv2D layer. The number of convolution filters in the Conv2D layer is 64, and a convolution kernel thereof has a (3,3) size. The pooling layer may include the max pooling layer, and the activation function may include the ReLU function ReLU.

A fourth convolution layer includes a Conv2D layer. The number of convolution filters in the Conv2D layer is 64, and the convolution kernel thereof has a (3,3) size. The pooling layer may include the max pooling layer. The activation function may include the ReLU function ReLU.

A flatten layer converts a 2-dimensional image data (matrix) which has passed through the convolution layer into one-dimensional data (array) which may be used as an input to a neural network. A dense layer connects inputs and outputs to each other to form a fully connected layer. For example, when there are 64 inputs and 1 output, the dense layer generates a 64×1 fully connected layer.

In one embodiment, the model generator 190 may apply the dataset including each of arc images classified into arc images of five welding state types: optimal state, low heat input, high heat input, high current, and high voltage and the welding quality associated with each corresponding arc image to the deep-learning model as shown in FIG. 17 to generate the arc image-based welding quality inspection model.

For example, the dataset may include 2927 arc images classified into arc images of the 5 welding states, wherein 1541 of the 2927 arc images have bad welding quality based on the arc length, and 1386 of the 2927 arc images have good welding quality based on the arc length. The dataset may be applied to the deep-learning model as shown in FIG. 17 to generate the arc image-based welding quality inspection model. In one embodiment, a portion of the dataset may be used as a training dataset for generating the arc image-based welding quality inspection model, while the remaining portion therefor may be used as a verification dataset to verify the generated arc image-based welding quality inspection model.

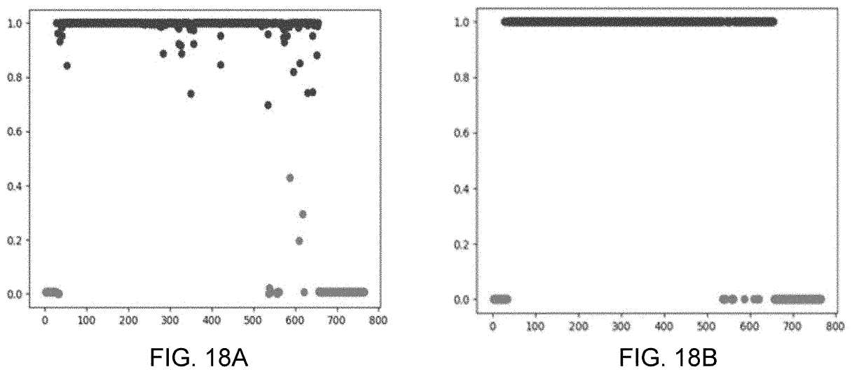

FIGS. 18A-B are diagrams showing an output value predicted through the arc image-based welding quality inspection model.

FIG. 18A is a diagram showing a prediction result calculated by inputting data corresponding to the optimal welding state that has not been applied to the deep-learning mode to generate the arc image-based welding quality inspection model to the arc image-based welding quality inspection model generated using the deep-learning model as described above. The closer the output value predicted through the arc image-based welding quality inspection model is to 0, the closer the welding quality is to a bad quality. The closer the output value predicted through the arc image-based welding quality inspection model is to 1, the closer the welding quality is to a good quality. Referring to FIG. 18B, when the value predicted through the arc image-based welding quality inspection model is greater than 0.5, 1 may be output. When the predicted value is smaller than 0.5, 0 may be output. This is indicated in FIG. 18B.

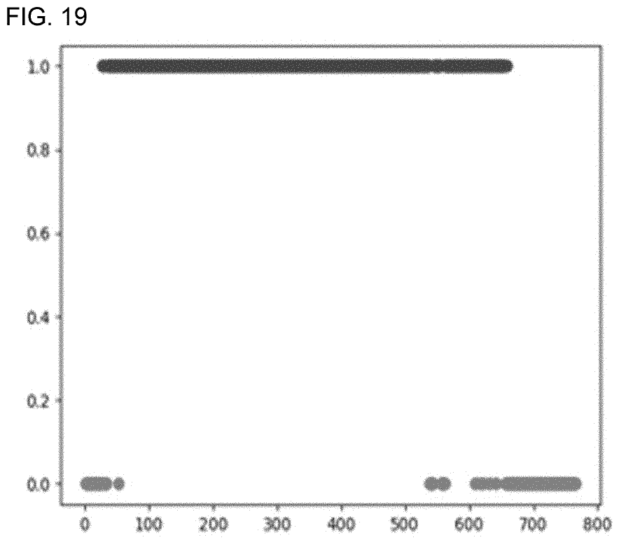

FIG. 19 is a diagram showing a result of determining a welding quality based on an arc length measured based on an actual arc image.

Referring to FIG. 19, compared to FIG. 18B, it may be identified that the prediction result of the prediction model and a result of determining the welding quality based on the actual arc image are very similar to each other. In the experimental example, the prediction result of the prediction model and the result of determining the welding quality based on the actual arc image are different from each other in 8 arc images out of a total of 766 arc images. Thus, an error percentage of the prediction model is 1.04%. Therefore, it may be identified that the prediction accuracy of the arc image-based welding quality inspection model is high, and that the welding quality may be determined only based on the arc image.

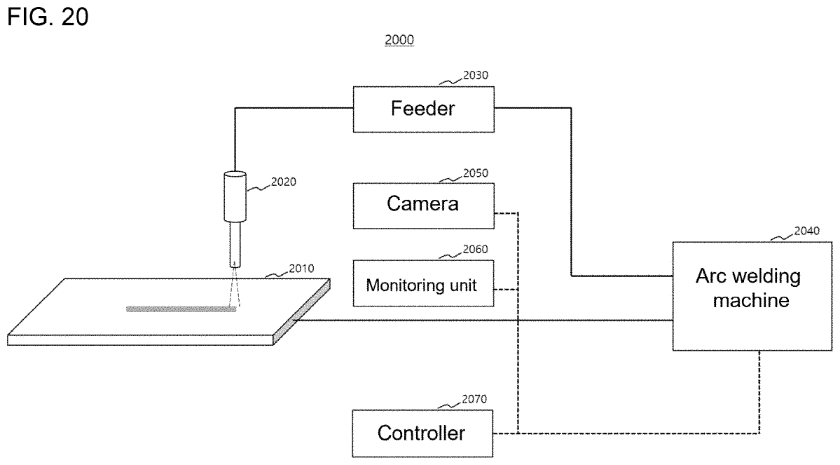

FIG. 20 is a diagram showing a configuration of an arc image-based welding quality monitoring apparatus according to an embodiment of the present disclosure.

Referring to FIG. 20, an arc image-based welding quality monitoring apparatus 2000 includes a welding bed 2010, a welding machine torch 2020, a feeder 2030, an arc welding machine 2040, a camera 2050, a monitoring unit 2060, and a controller 2070. In one embodiment, the arc image-based welding quality monitoring apparatus 2000 may further include a hall sensor, a voltage meter, and a DAQ board.

Hereinafter, for convenience of description, differences thereof from the apparatus 100 for generating the arc image-based welding quality inspection model using deep-learning in FIG. 1 will be described.

The controller 2070 controls the welding bed 2010, the feeder 2030 and the arc welding machine 2040 to control the welding process. During the welding process, the controller 2070 controls the camera 2050 to capture a welding target area on which the arc welding machine performs welding.

The camera 2050 captures an image of the welding target area on which the arc welding machine performs welding and transmits the captured image to the monitoring unit 2060. The monitoring unit 2060 acquires an arc image based on the image taken through the camera 2050 and identify the welding quality based on the arc image, and thus monitors whether the welding quality is bad. In one embodiment, the monitoring unit 2060 inputs the acquired arc image to the arc image-based welding quality inspection model to output a predicted value. In one embodiment, the monitoring unit 2060 may output 1 (good) when the value predicted through the arc image-based welding quality inspection model is greater than 0.5, and may output 0 (bad) when the value predicted through the arc image-based welding quality inspection model is smaller than 0.5.

The monitoring unit 2060 may pre-store the arc image-based welding quality inspection model, and may update the model under control of the controller. In one embodiment, the monitoring unit 2060 may receive an updated version of the arc image-based welding quality inspection model through a wired or wireless network (not shown).

When the welding quality is bad, the monitoring unit 2060 may display bad related information (for example, a welding condition, a defect occurrence time, a welding state at the defect occurrence time, a welding current, a welding voltage, etc.) on a display (not shown). In one embodiment, the monitoring unit 2060 may transmit the bad related information to a user terminal through a network (not shown).

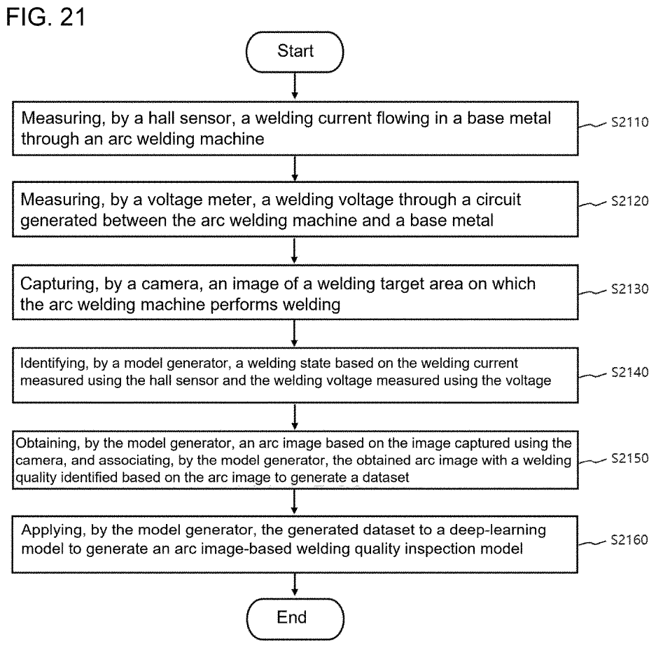

FIG. 21 is a flowchart for illustrating a method for generating an arc image-based welding quality inspection model using deep-learning according to an embodiment of the present disclosure.

Referring to FIG. 21, during a welding process, the hall sensor 150 measures the welding current flowing in the base metal through the arc welding machine 140 in S2110. The voltage meter 155 measures the welding voltage via a circuit generated between the arc welding machine 140 and the base metal in S2120. In one embodiment, the arc welding machine 140 may be embodied as a tip-rotating arc welding machine.

The camera 170 captures an image of the welding target area welded by the arc welding machine 140 and transmits the image to the model generator 190 in S2130. The model generator 190 identifies the welding state based on the measured welding current and the measured welding voltage in S2140. In one embodiment, the welding state may include an optimal state, a low heat input state, a high heat input state, a high voltage state, and a high current state.

The model generator 190 acquires an arc image based on the image captured by the camera 170, and associates the obtained arc image with the welding quality identified based on the arc image to generate a dataset in S2150. In one embodiment, the model generator 190 may obtain an arc area from the acquired arc image, may calculate the length of the arc based on the arc area, may identify whether the welding quality is good or bad based on the calculated arc length, and may associate the welding quality with the arc image to generate a dataset. In one embodiment, the model generator 190 may threshold the remaining pixel area except for the pixel area having a preset RGB value in the arc image to obtain the arc area. When a plurality of arc areas are extracted after thresholding, the model generator 190 may extract the arc area included in a preset bounding box. The model generator 190 may calculate the arc length based on the number of pixels in the extracted arc area.

The model generator 190 may apply the generated dataset to the deep-learning model to generate the arc image-based welding quality inspection model in S2160. A process of applying the dataset to the deep-learning model to generate the arc image-based welding quality inspection model is as described in FIG. 17.

The method for generating the arc image-based welding quality inspection model using deep-learning, the apparatus for generating the arc image-based welding quality inspection model using deep-learning, and the arc image-based welding quality monitoring apparatus using the same as described through FIG. 1 to FIG. 21 may be implemented in a form of a recording medium including instructions executable by a computer.

Although the present disclosure has been described based on embodiments of the present disclosure, the technical idea of the present disclosure is not limited to the above embodiments. The method for generating an arc image-based welding quality inspection model using deep-learning, the apparatus for generating an arc image-based welding quality inspection model using deep-learning, and the arc image-based welding quality monitoring apparatus using the same may be modified within the scope of the present disclosure.

What is claimed is:

1. An apparatus for generating arc image-based welding quality inspection model using deep-learning, the apparatus comprising:
a welding bed for fixing a base metal and for transferring the base metal at a preset speed;
a feeder for supplying a filler metal;
an arc welding machine for welding the filler metal supplied from the feeder to the base metal using an arc;
a hall sensor for measuring a welding current flowing in the base metal through the arc welding machine;
a voltage meter for measuring a welding voltage through a circuit generated between the arc welding machine and the base metal;
a camera for capturing an image of a welding target area on which the arc welding machine performs welding;
a controller for controlling the welding bed, the feeder, and the arc welding machine to control a welding process, and for controlling the hall sensor, the voltage meter, and the camera to collect welding-related data during the welding process; and
a model generator configured to:
identify a welding state based on the welding current measured using the hall sensor and the welding voltage measured using the voltage meter;
obtain an arc image based on the image captured using the camera;
associate the obtained arc image with a welding quality identified based on the arc image to generate a dataset; and
apply the generated dataset to a deep-learning model to generate an arc image-based welding quality inspection model.

2. The apparatus of claim 1, wherein the arc welding machine includes a tip-rotating arc welding machine.

3. The apparatus of claim 1, wherein the welding state includes an optimal state, a low heat input state, a high heat input state, a high voltage state, and a high current state.

4. The apparatus of claim 1, wherein the model generator is further configured to:
obtain an arc area from the acquired arc image;
calculate a length of the arc based on the arc area;
determine whether the welding quality is good or bad, based on the calculated arc length; and
associate the determined welding quality and the obtained arc image with each other to generate the dataset.

5. The apparatus of claim 4, wherein the model generator is further configured to:
classify the arc image as an arc image corresponding to each of welding states including an optimal state, a low heat input state, a high heat input state, a high current state, and a high voltage state; and
associating the welding quality identified based on the arc length calculated from each of the classified arc images with each of the classified arc images to generate a predefined number or greater of datasets.

6. The apparatus of claim 4, wherein the model generator is further configured to threshold a remaining pixel area except for a pixel area having preset RGB values in the arc image to obtain the arc area.

7. The apparatus of claim 6, wherein when a plurality of arc areas are extracted after the thresholding, the model generator is further configured to extract an arc area contained in a preset bounding box.

8. The apparatus of claim 7, wherein the model generator is further configured to calculate the length of the arc, based on a number of pixels of the extracted arc area.

9. The apparatus of claim 1, wherein the deep-learning model includes a first convolution layer, a second convolution layer, a third convolution layer, and a fourth convolution layer,
wherein the first convolution layer includes a Conv2D layer, a max pooling layer, and a ReLU activation function, wherein in the Conv2D layer, a number of convolution filters is 32, and a convolution kernel has a (3,3) size,
wherein the second convolution layer includes a Conv2D layer, a max pooling layer, and a ReLU activation function, wherein in the Conv2D layer, a number of convolution filters is 32, and a convolution kernel has a (3,3) size,
wherein the third convolution layer includes a Conv2D layer, a max pooling layer, and a ReLU activation function, wherein in the Conv2D layer, a number of convolution filters is 64, and a convolution kernel has a (3,3) size, and
wherein the fourth convolution layer includes a Conv2D layer, a max pooling layer, and a ReLU activation function, wherein in the Conv2D layer, a number of convolution filters is 64, and a convolution kernel has a (3,3) size.

10. A method for generating an arc image-based welding quality inspection model using deep-learning, the method comprising:
measuring, by a hall sensor, a welding current flowing in a base metal through an arc welding machine;
measuring, by a voltage meter, a welding voltage through a circuit generated between the arc welding machine and the base metal;
capturing, by a camera, an image of a welding target area on which the arc welding machine performs welding;
identifying, by a model generator, a welding state based on the welding current measured using the hall sensor and the welding voltage measured using the voltage meter;
obtaining, by the model generator, an arc image based on the image captured using the camera;
associating, by the model generator, the obtained arc image with a welding quality identified based on the arc image to generate a dataset; and
applying, by the model generator, the generated dataset to a deep-learning model to generate an arc image-based welding quality inspection model.

11. The method of claim 10, wherein associating, by the model generator, the obtained arc image with the welding quality identified based on the arc image to generate the dataset includes:
obtaining, by the model generator, an arc area from the acquired arc image;
calculating, by the model generator, a length of the arc based on the arc area;
determining, by the model generator, whether the welding quality is good or bad, based on the calculated arc length; and
associating, by the model generator, the determined welding quality and the obtained arc image with each other to generate the dataset.

12. The method of claim 11, wherein calculating, by the model generator, the length of the arc based on the arc area includes thresholding, by the model generator, a remaining pixel area except for a pixel area having preset RGB values in the arc image to obtain the arc area.

13. The method of claim 11, wherein a plurality of arc areas are extracted after the thresholding,
wherein obtaining, by the model generator, the arc area from the acquired arc image includes extracting, by the model generator, an arc area contained in a preset bounding box.

14. An apparatus for monitoring a welding quality based on an arc image, the apparatus comprising:
a welding bed for fixing a base metal and for transferring the base metal at a preset speed;
a feeder for supplying a filler metal;
an arc welding machine for welding the filler metal supplied from the feeder to the base metal using an arc;
a camera for capturing an image of a welding target area on which the arc welding machine performs welding;
a controller for controlling the welding bed, the feeder, and the arc welding machine to control the welding process; and
a monitoring unit configured to:
acquire an arc image based on the image captured using the camera; and
identify whether a welding quality is good or bad, based on the arc image.
